(19) United States
(12) Patent Application Publication
(10) Pub. No.: US 2026/0145782 A1
(43) Pub. Date: May 28, 2026

(54) MECHANICAL FLIGHT CONTROL SYSTEM OF AN AIRCRAFT WITH MEASUREMENT OF A FORCE IN THE MECHANICAL FLIGHT CONTROL SYSTEM

(71) Applicant: AIRBUS HELICOPTERS, Marignane Cedex (FR)

(72) Inventors: Clément LETONNELIER, La Fare Les Oliviers (FR); Pascal IZZO, Berre L'Etang (FR); Antoine MAUSSION, La Fare Les Oliviers (FR)

(73) Assignee: AIRBUS HELICOPTERS, Marignane Cedex (FR)

(21) Appl. No.: 19/306,014

(22) Filed: Aug. 21, 2025

(30) Foreign Application Priority Data
Nov. 28, 2024 (FR) FR2413153

(51) Int. Cl. B64C 13/30; B64D 45/00

(52) U.S. Cl. CPC B64C 13/30; B64D 45/00

(57) ABSTRACT

A mechanical flight control system of an aircraft provided with an actuator and a force-measuring device, the actuator comprising at least one electric motor and one duplex calculator per motor, each duplex calculator comprising a control channel, a monitoring channel and two input interfaces, the force-measuring device comprising a plurality of measurement channels each comprising a sensor, an electronic module and an output interface connected to one of the input interfaces. the electronic module is connected to the sensor in order to generate an analog measurement signal and is configured to digitize the analog measurement signal, at least one of the measurement channels applying a delta-sigma modulation, and then to convert it into a digital transfer signal carrying a transfer value representative of a force in the mechanical flight control system.

### CROSS REFERENCE TO RELATED APPLICATION

This application claims priority to French patent application No. FR 24 13153 filed on Nov. 28, 2024, the disclosure of which is incorporated in its entirety by reference herein.

### TECHNICAL FIELD

The present disclosure is in the field of aircraft flight control systems.

### BACKGROUND

The present disclosure relates to a mechanical flight control system for an aircraft, comprising a force-measuring device, and to an aircraft provided with this mechanical flight control system. The present disclosure also relates to a method for measuring a value representative of a force in a mechanical flight control system of an aircraft.

An aircraft may comprise mobile aerodynamic control surfaces controlled by a mechanical flight control system in order to steer the aircraft. Such aerodynamic control surfaces may comprise rotor blades, propeller blades, ailerons or rudders for example.

A mechanical flight control system may comprise several connecting rods forming a linkage between a control member, such as a lever, a stick or a rudder bar, and an aerodynamic control surface to be moved, optionally via a servo-control. A mechanical flight control system may also comprise one or more actuators.

For example, a series actuator may be interposed between two connecting rods of the mechanical flight control system, an extension or retraction of this series actuator causing a change in the order transmitted to the servo-control without having any effect on the position of the control member.

In another example, a parallel actuator, also known as a “trim actuator”, may connect the control member or a connecting rod of the mechanical flight control system to a fixed point on the structure of the aircraft. Such a parallel actuator may, for example, cause simultaneous changes in the order transmitted to the servo-control and in the position of the control member. This parallel actuator may also enable the control member to be anchored in a determined position. Such a parallel actuator may also act as a gentle or straightforward stop, to indicate, in particular, to a pilot that a flight limit has been reached and/or exceeded, or even a haptic return.

In addition, in order to achieve the required level of safety, these actuators may comprise two motors, respectively controlled by separate, or even dissimilar, duplex calculators. Such duplex calculators thus comprise a first calculation channel dedicated to the control of the movements of the actuator and a second calculation channel dedicated to the monitoring the first calculation channel, and making it possible, if necessary, to inhibit it in the event of detection of an anomaly or a fault.

Regardless of their type, these actuators can be servo-controlled as a function of a force. For this purpose, and in order to adapt the actuator control setpoint, a force measurement is necessary in the mechanical flight control system, and in particular on a connecting rod.

One or more analog-type force-measuring devices may, for example, be incorporated in a mechanical flight control system as described in document EP 3301019. Such force-measuring devices may be particularly sensitive to constrained environments. Moreover, these force-measuring devices can induce non-negligible friction on the control members due to the numerous electrical connecting wires of these devices.

Furthermore, the signal provided by a force-measuring device arranged on a mechanical flight control system may be processed and/or filtered in order to improve its resolution or to limit its noise, for example. An analog signal may also be converted into a digital signal as described, for example, in document US 2014/0266259.

To meet a high level of safety attached to a mechanical flight control system of an aircraft, such a force-measuring device arranged on the mechanical flight control system may be of the duplex type, namely comprising two independent measurement channels, or even quadruplex, namely comprising four independent measurement channels. In particular, the use of a quadruplex force-measuring device makes it possible to achieve a failure occurrence rate of less than or equal to 10⁻⁶/flight hour for a loss of one or more measurement channels of the force-measuring device as well as a failure occurrence rate of less than or equal to 10⁻¹⁰/flight hour for the emission of an undetected erroneous signal on one or more measurement channels and for a mechanical failure leading to a loss of the control member.

In addition, documents US 2019/0233087, US 2019/0300169, EP 0606469 and US 2022/0380023 as well as the publication by Holger FLÜHR, “Avionik und Flugsicherungstechnik: Einführung in Kommunikationstechnik, Navigation, Surveillance” (2013 Feb. 06), XP055488213 are also known.

### SUMMARY

An object of the present disclosure is therefore an innovative method for measuring a force in a mechanical flight control system of an aircraft. Other objects of the present disclosure are a mechanical flight control system comprising a force sensor capable of applying such a method, and an aircraft comprising such a mechanical flight control system.

The present disclosure thus relates to a mechanical flight control system of an aircraft comprising at least one connecting rod and one actuator, the actuator comprising at least one electric motor and one duplex calculator per motor, each duplex calculator comprising a control channel, a monitoring channel and two input interfaces connected respectively to the control channel and to the monitoring channel. The mechanical flight control system also comprises a force-measuring device arranged on the connecting rod and configured to control the actuator. The control and monitoring channels of each duplex calculator constitute calculation channels of this duplex calculator.

The force-measuring device comprises at least two measurement channels respectively connected to the two input interfaces of said at least one duplex calculator and each of said measurement channels comprises a sensor, an electronic module and an output interface. The output interface is connected to one of the input interfaces of said at least one duplex calculator, the electronic module being connected to the sensor in order to generate an analog measurement signal, the electronic module being configured to perform a digitization of the analog measurement signal to convert it into a digital measurement signal, the electronic module being configured to perform a conversion of the digital measurement signal into a digital transfer signal carrying a transfer value representative of a force in the mechanical flight control system. At least one of the measurement channels applies a delta-sigma modulation to digitize the analog measurement signal and applies Manchester coding and low-voltage differential signaling in order to convert the digital measurement signal to obtain the digital transfer signal, the mechanical flight control system comprising one clock per measurement channel intended to clock the delta-sigma modulation.

The mechanical flight control system may be connected at one of its ends to a control member, such as a stick, a lever or a rudder bar, for example, and at another of its ends to an aerodynamic control surface of the aircraft, such as one or more blades of a rotor or one or more flaps for example, optionally via a servo-control.

The electronic module may comprise a printed circuit carrying electronic components such as integrated circuits and/or microswitches. In this case, this electronic module does not apply programs stored in a memory to carry out the steps of the method.

Alternatively, the electronic module may comprise a calculator, for example a microcontroller, and a memory storing a program applied by the calculator to carry out the steps of the method.

The analog measurement signal carries a value measured by the sensor, this measured value being a function of a force undergone or transmitted by the mechanical flight control system, and in particular by the connecting rod of this mechanical flight control system.

The delta-sigma modulation makes it possible to convert the measured value acquired in analog form into a digitized value carried by the digital measurement signal. This digital measurement signal is coded on one or more bits, by oversampling, for which the rate of variation, between 0 and 1, is a function of the amplitude of the analog measurement signal. This delta-sigma modulation is clocked by the clock relating to the measurement channel concerned. The use of the time signal emitted by this clock and the frequency of this time signal influence the resolution of the digital measurement and transfer signals, as well as their accuracy. This digitized value carried by the digital measurement signal is a function of the measured value and therefore also of the force undergone or transmitted by the mechanical flight control system.

Then, Manchester coding and low-voltage differential signaling (LVDS) enable the digitized value carried by the digital measurement signal to be converted into the transfer value carried by the digital transfer signal. Manchester coding is a synchronous coding that has the advantage of transmitting, by means of this single digital transfer signal, the transfer value as well as the time signal provided by the clock. At each clock cycle, a bit is encoded either by a 0 to 1 or a 1 to 0 transition at mid-cycle, depending on whether the bit to be encoded is a “1” or a “0”, thus enabling the clock to be reconstituted by the receiver of the digital transfer signal.

Moreover, low-voltage differential signaling has the advantage of being more immune to electrical noise, supporting higher frequency signals and travelling longer distances than transistor-transistor logic-type (TTL) physical layers. Low-voltage differential signaling further requires the use of twisted wires and smaller lightning protections.

The transfer value carried by the digital transfer signal is thus a function of the digitized value and therefore also of the force undergone or transmitted by the mechanical flight control system.

This mechanical flight control system therefore advantageously makes it possible, through the processing operations applied successively to the analog measurement signal and to the digital measurement signal, for a precise transfer value, that is not very sensitive in particular to electromagnetic disturbances, and that is representative of the force in the mechanical flight control system, to be transmitted to the actuator in order to control it optimally.

This actuator may be, for example, a series actuator connecting two connecting rods of the mechanical flight control system. This actuator may also be a parallel actuator connecting the control member or a connecting rod of the mechanical flight control system to a fixed point of the structure of the aircraft. The actuator may be hydraulic, pneumatic or electric. The flight control system thus makes it possible to control the movements of an aerodynamic control surface, for example by controlling the pitch of the blades or the orientation of the flaps, optionally via the servo-control.

The mechanical flight control system according to the disclosure may also comprise one or more of the following features, taken individually or in combination.

According to one possibility, the sensor may comprise at least one strain gauge, one piezoelectric sensor or one linear displacement sensor known as a “linear variable differential transformer” (LVDT). This sensor can then measure a displacement or a deformation of the connecting rod that is a function of the force undergone or transmitted by this connecting rod in the flight control system between the control member and the servo-control of an aerodynamic control surface.

Each measurement channel may comprise a sensor of the same type. Alternatively, at least two measurement channels may respectively comprise sensors of different types, to contribute to a dissimilarity of these at least two measurement channels.

According to one possibility compatible with the preceding possibilities, the force-measuring device may comprise clocks. In particular, the electronic module of each measurement channel may comprise a clock, thus ensuring the independence of each of the measurement channels.

Alternatively, the actuator may comprise clocks. In particular, a duplex calculator of this actuator may comprise such a clock on each of the control and monitoring channels. The time signal of each clock is then transmitted to the measurement channels of the force-measuring device, via the input and output interfaces. As a result, the force-measuring device can be simplified, lighter and less expensive when it does not comprise such a clock.

According to one possibility compatible with the preceding possibilities, for at least one of the measurement channels, the electronic module may comprise an analog-to-digital converter for digitizing the analog signal and the output interface comprises a digital bus.

The measurement channel or channels comprising such an analog-to-digital converter is/are one or more measurement channels not applying delta-sigma modulation.

Advantageously, the processing of the analog measurement signal is thus dissimilarly performed by at least two measurement channels, at least one measurement channel applying delta-sigma modulation and at least one measurement channel applying analog-to-digital conversion.

In this way, at least two measurement channels are dissimilar, at least in terms of the digitization method used. In addition, the electronic module may be different for this or these measurement channels, also providing technological dissimilarity.

For example, the digital bus may be of a known type chosen from the types: TIA/EIA-485, TIA/EIA-422, ARINC 429, CAN bus, I2C, AFDX, Time-Triggered Ethernet, FlexRay, LIN or MIL-STD-1553.

According to one possibility compatible with the preceding possibilities, at least one of the measurement channels may comprise a memory wherein at least one calibration law is stored, and said at least one duplex calculator is configured to apply a calibration of the transfer value carried by the digital transfer signal for each measurement channel using said at least one calibration law.

More specifically, it is known that the value measured by the sensor can be modified or can drift before it is transmitted by the force-measuring device. This drift may be related to various factors such as electrical voltage, temperature and/or aging of each measurement channel, for example. Errors can also be introduced by drifts of the electronic components used on the measurement channels, or even by the sensor.

In this way, the value measured by the sensor and carried by the analog measurement signal may be different from the transfer value carried by the digital transfer signal.

The calibration can thus improve the accuracy of the transfer value representative of the force in the mechanical flight control system for each measurement channel.

The modifications or deviations to be corrected may be determined by calculations, tests or simulations and implemented in the calibration law or laws. Depending on the complexity of the corrections to be made, the calibration law may comprise a single calibration formula, a table comprising several calibration formulas, or a calibration table.

The single calibration formula gives a corrected value representative of the force as a function of the transfer value. The table of calibration formulas comprises a plurality of formulas, the formula to be applied to obtain the corrected value representative of the force being defined as a function of the transfer value. The calibration table comprises a correspondence table between transfer values and corrected values.

Furthermore, the calibration law may be generic and identical for all measurement channels. Alternatively, the calibration law may be specific to each of the measurement channels, in particular when they are dissimilar, and therefore different from one measurement channel to another.

Said at least one duplex calculator of the actuator can thus apply the calibration to each control and monitoring channel in order to correct the transfer value carried by the digital transfer signal received from each measurement channel, said at least one measurement channel comprising the memory transferring said at least one calibration law to the duplex calculator.

Alternatively, this calibration may be performed by the force-measuring device, and by each measurement channel, before emission of the digital transfer signal.

Alternatively, the actuator may comprise at least one memory wherein the calibration law or laws are stored, and said at least one duplex calculator is configured to apply a calibration of the transfer value carried by the digital transfer signal for each measurement channel using said at least one calibration law.

In this case, the calibration law or laws may be stored in at least one memory of said at least one duplex calculator of the actuator, the measurement channels not storing any calibration law.

For example, in the presence of a single duplex calculator, each control and monitoring channel of this duplex calculator may comprise a memory storing the calibration law or laws, this duplex calculator applying such a calibration law to the transfer value carried by the digital transfer signal travelling in the control channel and the monitoring channel of this duplex calculator.

According to one possibility compatible with the preceding possibilities, the actuator may comprise two electric motors and two duplex calculators, the force-measuring device comprising two first measurement channels connected to the control channels of the two duplex calculators and two second measurement channels connected to the monitoring channels of the two duplex calculators, the first measurement channels being dissimilar to the second measurement channels.

The use of two duplex calculators associated with four measurement channels of the force-measuring device thus makes it possible to obtain a quadruplex device capable of mitigating faults, both at the level of a measurement channel of the force-measuring device and at the level of a control or monitoring channel of a duplex calculator. Moreover, the use of dissimilar measurement channels, depending on whether they are connected to the control or monitoring channels of the duplex calculators, makes it possible to limit the sensitivity of the force-measuring device to certain failures.

The mechanical flight control system according to the disclosure thus makes it possible to improve the resistance to failure of the force-measuring device and/or of the actuator. In particular, the mechanical flight control system according to the disclosure can thus achieve a high level of safety, corresponding, for example, to a failure occurrence rate of less than or equal to 10⁻¹⁰ per flight hour.

The disclosure also relates to an aircraft provided with at least one mobile aerodynamic control surface for steering said aircraft and comprising at least one mechanical flight control system as described above for controlling said aerodynamic control surface.

Another object of the disclosure is a method for measuring a value representative of a force in a mechanical flight control system of an aircraft using a force-measuring device.

The force-measuring device is provided with at least two measurement channels each comprising a sensor arranged on a connecting rod of the flight control system, an electronic module and an output interface, the method comprising the following steps applied for each measurement channel of the force-measuring device:
Generating an analog measurement signal using the sensor;
digitizing the analog measurement signal to form a digital measurement signal using the electronic module;
converting the digital measurement signal into a digital transfer signal by means of the electronic module, the digital transfer signal carrying a transfer value representative of the force in the mechanical flight control system;
emitting, by the electronic module, the digital transfer signal via the output interface of the measurement channel; and
calibrating said transfer value by application of a calibration law, said calibration law comprising a single calibration formula, a table of calibration formulas, or a calibration table;
on at least one measurement channel, said digitization being performed by a delta-sigma modulation clocked by a clock, said conversion being performed by a Manchester coding and a low-voltage differential signaling.

The method according to the disclosure thus applies processing operations to the analog measurement signal carrying a measured value that is a function of the force in the mechanical flight control system of an aircraft in order to digitize it, and then to modify the digital measurement signal obtained in order to obtain the digital transfer signal carrying the transfer value that is emitted towards an item of equipment, and for example a series or parallel actuator of the mechanical flight control system.

As a result of these treatments, the transfer value is less sensitive to, or even immune to, an electromagnetic environment and is more precise compared to current stress measurement solutions, by protecting against losses of precision related to the transmission of purely analog signals and potential noise introductions due to disturbances. The use of delta-sigma modulation also contributes to good precision of the value representative of the force.

This method may in particular be implemented by the mechanical flight control system described above.

### BRIEF DESCRIPTION OF THE DRAWINGS

The disclosure and its advantages appear in greater detail from the following description of examples given by way of illustration with reference to the accompanying figures, wherein:

FIG. 1 is a view of a mechanical flight control system according to the disclosure;

FIG. 2 is a view of an aircraft comprising the mechanical flight control system of FIG. 1;

FIG. 3 is a partial view of the mechanical flight control system of FIG. 1; and

FIG. 4 is a partial view of the mechanical flight control system of FIG. 1.

### DETAILED DESCRIPTION

Elements present in more than one of the figures are given the same references in each of them.

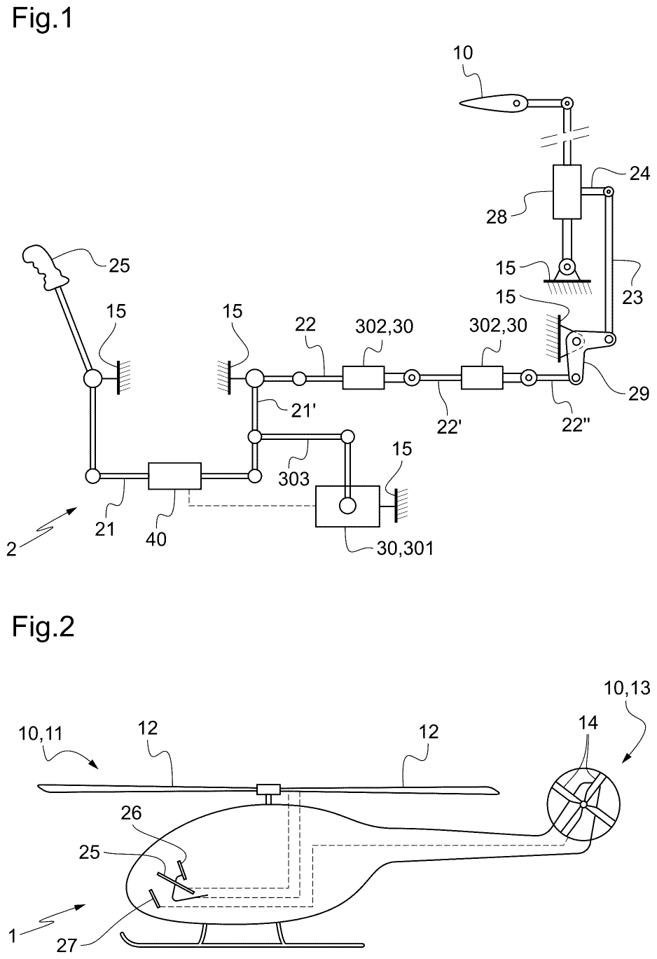

FIG. 1 shows a mechanical flight control system 2 for an aircraft 1.

Such a mechanical flight control system 2 controls, possibly via a servo-control 28, movements of one or more aerodynamic control surfaces 10 making it possible to steer the aircraft 1. Such aerodynamic control surfaces 10 may include first blades 12 of a main rotor 11, second blades 14 of a yaw motion control rotor 13, or even propeller blades, ailerons or rudders.

According to the example in FIG. 2, the aircraft 1 may be a helicopter comprising a main rotor 11 provided with first variable-pitch blades 12 and a yaw motion control rotor 13 provided with second variable-pitch blades 14. In this case, the aircraft 1 may comprise a plurality of mechanical flight control systems 2 respectively controlling a collective variation of the pitch of the first blades 11 by means of a collective pitch lever 25, a cyclic variation of the pitch of the first blades 12 by means of a cyclic pitch stick 26, and a collective variation of the pitch of the second blades 14 by means of a rudder bar 27.

Independently of the nature of the aerodynamic control surfaces 10, the mechanical flight control system 2 comprises a control member 25, 26, 27 and a plurality of connecting rods 21, 21′, 22, 22′, 22″, 23, 24 articulated to one another, optionally via a bellcrank 29 or even a combiner. The mechanical flight control system 2 also comprises one or more actuators 30, as well as a force-measuring device 40. Reference sign “30” designates any of the actuators of a mechanical flight control system 2, reference signs “301, 302” designating specific actuators if necessary.

According to the example in FIG. 1, a mechanical flight control system 2 may comprise at least one parallel actuator 301 and at least one series actuator 302.

The parallel actuator 301 connects, according to the example illustrated, a connecting rod 21′ of the mechanical flight control system 2, via a connecting rod 303, to a fixed point of the structure 15. This parallel actuator 301 may comprise, for example, a cylinder or an electric motor.

According to the example illustrated, two series actuators 302 can connect two of the connecting rods 22, 22′, 22″ of the mechanical flight control system 2 via one of their respective ends. These series actuators 302 may, for example, each comprise an electric cylinder.

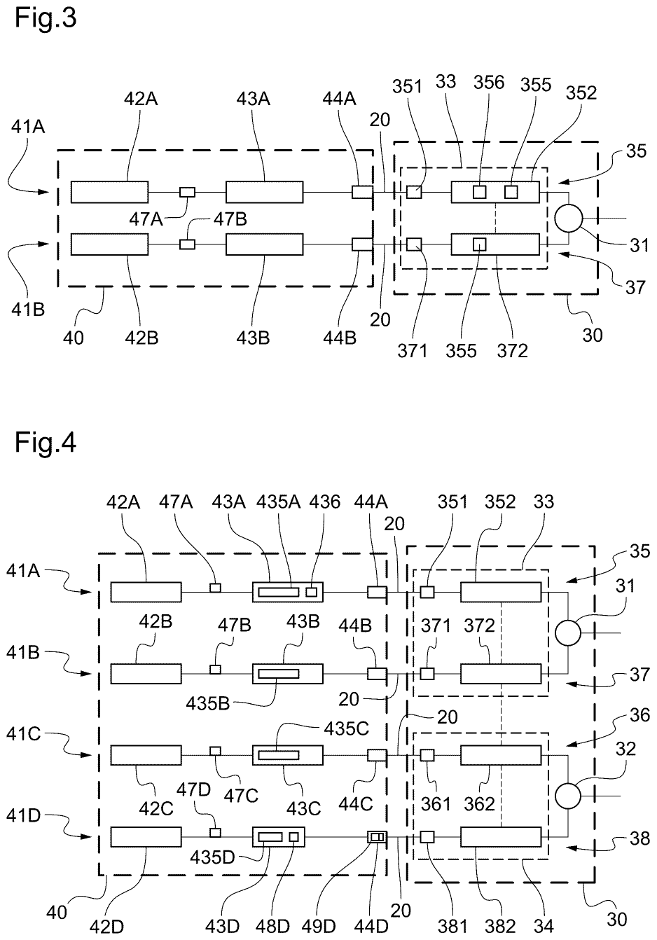

Independently of its type and as shown in FIGS. 3 and 4, the actuator 30 comprises at least one electric motor 31, 32 and one duplex calculator 33, 34 per motor 31, 32. Each duplex calculator 33,34 is provided with two independent calculation channels, namely a control channel 35, 36 and a monitoring channel 37, 38, as well as one input interface 351, 361, 371, 381 per calculation channel 35, 36, 37, 38.

Each calculation channel 35, 36, 37, 38 comprises a processing unit 352, 362, 372, 382 that may, for example, comprise a processor, at least one integrated circuit, at least one logic circuit, these examples not limiting the scope given to the expression “processing unit”. The term “processor” may refer equally to a central processing unit or CPU, a graphics processing unit or GPU, a digital signal processor or DSP, a microcontroller, etc.

The force-measuring device 40 is arranged in the mechanical flight control system 2, and, for example, on one of the connecting rods 21-24. This force-measuring device 40 enables, in particular, a force undergone or transmitted by this connecting rod 21-24 to be measured directly or indirectly.

The force-measuring device 40 comprises at least two measurement channels 41, each provided with a sensor 42 arranged on the connecting rod 21-24, an electronic module 43 and an output interface 44. A numerical reference sign alone “41”, “42”, “43”, “44” generally designates a measuring channel or one of its components, a letter “A”, “B”, “C” or “D” being associated with these numerical references to designate a specific measuring channel or one of its components, if necessary.

The electronic module 43 may, for example, comprise various electronic components, such as integrated circuits, microswitches, and/or passive electronic components, connected to one another by a printed circuit or equivalent.

The output interface 44 of each measurement channel 41 is electrically connected, via an electrical harness 20, to a single input interface 351, 361, 371, 381 of a calculation channel 35, 36, 37, 38 of the actuator 30, each input interface 351, 361, 371, 381 being connected to a single output interface 44.

For example, the sensor 42 may comprise at least a strain gauge, a piezoelectric sensor or a linear variable differential transformer (LVDT). For these examples, this sensor 42 can measure a displacement or a deformation of the connecting rod 21-24 that is a function of, or even proportional to, the force undergone or transmitted by this connecting rod 21-24, and consequently the force undergone or transmitted by the flight control system 2.

The measurement channels 41 may optionally comprise sensors 42 of different types in order, in particular, to make these measurement channels 41 dissimilar.

Exemplary embodiments of the force-measuring device 40 and the actuator 30 are shown in FIGS. 3 and 4.

According to a first example shown in FIG. 3, the force-measuring device 40 comprises two measurement channels 41A, 41b and the actuator 30 comprises a single duplex calculator 33. The two measurement channels 41A, 41B are connected to the control channel 35 and the monitoring channel 37, respectively via the output interfaces 44A, 44B and the input interfaces 351, 371.

The processing unit 352 of the control channel 35 of the duplex calculator 33 comprises a clock 355 and a memory 356, the processing unit 372 of the monitoring channel 37 of this duplex calculator 33 also comprising a clock 355.

According to a second embodiment shown in FIG. 4, the force-measuring device 40 comprises four measurement channels 41A, 41B, 41C, 41D and the actuator 30 comprises two duplex calculators 33, 34. The four measurement channels 41A, 41B, 41C, 41D are connected respectively to the control channel 35, 36 and the monitoring channel 37, 38, via the output interfaces 44A, 44B, 44C, 44D and the input interfaces 351, 361, 371, 381.

The electronic module 43A, 43B, 43C, 43D of the four measurement channels 41A, 41B, 41C, 41D comprises a clock 435A, 435B, 435C, 435D, the electronic module 43A of the first measurement channel 41A also comprising a memory 436.

According to this second example, the two measurement channels 41A, 41C that are connected to the control channels 35, 37 of the two duplex calculators 33, 34 may be dissimilar to the two measurement channels 41B, 41D connected to the monitoring channels 36, 38 of the two duplex calculators 33, 34.

Independently of these two exemplary embodiments, each measurement channel 41 generates, by means of the sensor 42, an analog measurement signal carrying a measured value that is a function of the force undergone or transmitted in the mechanical flight control system 2. The electronic module 43 of each measurement channel 41 receives this analog measurement signal and can apply various processes to it to first digitize it in order to obtain a digital measurement signal carrying a digitized value that is a function of the measured value and, consequently, of the force undergone or transmitted in the mechanical flight control system 2. Secondly, the electronic module 43 converts the digital measurement signal into a digital transfer signal carrying the transfer value as a function of the digitized value and consequently of the force undergone or transmitted in the mechanical flight control system 2.

In particular, the electronic module 43 of at least one of the measurement channels 41, or even of each measurement channel 41, applies a delta-sigma modulation to digitize the analog measurement signal, then a Manchester coding and a low-voltage differential signaling to obtain the digital transfer signal.

The transfer value thus obtained is precise and relatively immune to an electromagnetic environment.

The time signal of the clock 355, 435 is used in particular by the electronic modules 43 to carry out the delta-sigma modulation and to apply the Manchester coding. Furthermore, when the clock 355 is located in the duplex calculator 33, 34, the time signal is transmitted to each measurement channel 41 via the input 351, 361, 371, 381 and output 44 interfaces.

In addition to at least one of the measurement channels 41A applying a delta-sigma modulation, and as shown in FIG. 4, the electronic module 43D of at least one other measurement channel 41D may comprise an analog-to-digital converter 48D for digitizing the analog measurement signal, and the output interface 44D of this at least one other measurement channel 41D then comprises a digital bus 49D in order to enable the conversion of the digital measurement signal into a digital transfer signal. In this case, this other measurement channel 41D does not apply delta-sigma modulation or Manchester coding. The mechanical flight control system 2 according to the disclosure thus advantageously comprises at least two dissimilar measurement channels 41A, 41D, thus making it possible to mitigate failures likely to affect the measurement channels 41.

Furthermore, the memory 356, 436 may store one or more calibration laws. This or these calibration laws make it possible to correct deviations between the transfer value carried by the digital transfer signal and the value measured by the sensor 42.

A first correction provided by this or these calibration laws may be obtained by implementing a so-called “static” calibration, that is a function of the transfer value alone. Such a static calibration can compensate, in particular, for gain and/or offset errors intrinsic to the measurement channel 41.

A second correction may be obtained by implementing a so-called “dynamic” calibration as a function of the transfer value and the temperature of the measurement channel 41 concerned. Such a dynamic calibration can rectify gain and offset errors related to the temperature of the measurement channel 41. In order to implement this dynamic calibration, a temperature sensor 47 may be integrated on each measurement channel 41 of the force-measuring device 40 to measure the temperature of each measurement channel 41.

Regardless of the correction implemented, a calibration law may comprise a single calibration formula, a table comprising several calibration formulas, or a calibration table. The single calibration formula gives a corrected value representative of the force as a function of the transfer value and, where applicable, the temperature of the measurement channel 41 for the dynamic calibration.

The table of calibration formulae comprises a plurality of formulas, the formula to be applied to obtain the corrected value representative of the force being defined as a function of the transfer value and, where appropriate, of the temperature of the measurement channel 41 for the dynamic calibration. A search for a close corrected value may also be performed using at least one algorithm, for example by dichotomy, in the case where this table does not provide formulas for the current transfer value.

The calibration table comprises a correspondence table between transfer values and corrected values and, if necessary, as a function of the temperature of the measurement channel 41 for the dynamic calibration. Here again, a search for a close corrected value may also be performed using at least one algorithm, for example by dichotomy, in the case where this table does not provide a corrected value for the current transfer value.

Thus, the one or more duplex calculators 33, 34 of the actuator 30 can calibrate the transfer value carried by the digital transfer signal received from each measurement channel 41 using the calibration law or laws. Alternatively, this calibration may be performed by the force-measuring device 40, and in particular by the electronic module 43 for each measurement channel 41, before the emission of the digital transfer signal.

According to the example in FIG. 3, the first processing unit 352 of the duplex calculator 33 of the actuator 30 comprises the memory 356 wherein the calibration law or laws are stored. This first processing unit 352 can therefore directly apply the calibration to the transfer value carried by the digital transfer signal received by the first control channel 35. In addition, the second processing unit 326 communicates with the first processing unit 352 to receive the calibration law or laws, in order to apply the calibration to the transfer value carried by the digital transfer signal received by the first monitoring channel 36.

In the presence of a plurality of duplex calculators 33, 34, only one of the duplex calculators 33, 34 may comprise the memory 352 and transmit this or these calibration laws to one or more other duplex calculators 33, 34 via a wired or wireless link. In this way, a single memory 352 is sufficient for the at least two duplex calculators 33, 34, simplifying at least one of these duplex calculators 33, 34 and also limiting its cost.

According to the example of FIG. 4, only the first electronic module 43A comprises the memory 436 storing the calibration law or laws. The calibration law or laws are then transmitted to at least one of the duplex calculators 33, 34 in order to produce the calibration of the transfer value on each of the control 35, 37 and monitoring 36, 38 channels.

In the presence of a plurality of duplex calculators 33, 34, one of these duplex calculators 33, 34 can receive the calibration law or laws via the measurement channel 41 storing it. Then, this duplex calculator 33, 34 can transmit the calibration law or laws to one or more other duplex calculators 33, 34 via a wired or wireless link.

Regardless of the correction implemented, the calibration law may be the same for all measurement channels 41. Alternatively, the calibration law may be different from one measurement channel 41 to another, in particular when these measurement channels 41 are dissimilar.

In the case of calibration laws specific to each measurement channel 41, a single measurement channel 41 may comprise the memory 436 to store all the calibration laws. Alternatively, each measurement channel 41 may comprise a memory 436 storing the calibration law to be applied specifically for that measurement channel 41. Alternatively, each measurement channel may comprise a memory 436 storing all the calibration laws relating to each of the measurement channels 41 in order to mitigate in this way a possible failure of one of the memories of these measurement channels 41.

In addition, the mechanical flight control system 2 can implement a method for measuring a value representative of a force in the mechanical flight control system 2 using a force-measuring device 40.

This method comprises the following steps applied for each measurement channel 41 of the force-measuring device 40:

First, an analog measurement signal is generated using the sensor 43 of each of the measurement channels 41, this analog measurement signal carrying the value measured by the sensor 43.

Then, a digitization of this analog measurement signal is performed using said electronic module 43 of each of the measurement channels 41 to form a digital measurement signal, carrying the digitized value.

This digital measurement signal is then converted into a digital transfer signal by means of the electronic module 43 of each of the measurement channels 41, the digital transfer signal carrying a transfer value representative of the force in the mechanical flight control system 2.

For at least one measurement channel 41, this digitization is carried out by a delta-sigma modulation clocked by a clock, and the conversion is carried out by Manchester coding and low-voltage differential signaling.

An emission of said digital transfer signal to said output interface of said measurement channel is performed, for example to the actuator 30, via these input interfaces 351, 361, 371, 381.

Finally, a calibration of the transfer value may be produced by applying a calibration law, this calibration law comprising a single calibration formula, a table of calibration formulas, or a calibration table.

This calibration can be implemented equally well in the one or more duplex calculators 33, 44 of the actuator 30 or even in the electronic modules 43 of the measurement channels 41 of the force-measuring device 40.

Naturally, the present disclosure may be subjected to numerous variations as to its implementation. Although several embodiments are described above, it should readily be understood that it is not conceivable to identify exhaustively all the possible embodiments. It is of course possible to replace any of the means described with equivalent means without going beyond the ambit of the present disclosure.

What is claimed is:

1. A mechanical flight control system of an aircraft, comprising at least one connecting rod and one actuator, the actuator comprising at least one electric motor and one duplex calculator per motor, each duplex calculator comprising a control channel, a monitoring channel and two input interfaces connected respectively to the control channel and to the monitoring channel, the mechanical flight control system comprising a force-measuring device arranged on the connecting rod and configured to control the actuator,
wherein the force-measuring device comprises at least two measurement channels respectively connected to the two input interfaces of the duplex calculator(s), and each of the measurement channels comprises a sensor, an electronic module and an output interface, the output interface being connected to one of the input interfaces of the duplex calculator(s), the electronic module being connected to the sensor in order to generate an analog measurement signal, the electronic module being configured to perform a digitization of the analog measurement signal in order to convert it into a digital measurement signal, the electronic module being configured to perform a conversion of the digital measurement signal into a digital transfer signal carrying a transfer value representative of a force in the mechanical flight control system, at least one of the measurement channels applying a delta-sigma modulation in order to digitize the analog measurement signal and applying Manchester coding and a low-voltage differential signaling to convert the digital measurement signal into the digital transfer signal, the mechanical flight control system comprising one clock per measurement channel intended to clock the delta-sigma modulation.

2. The mechanical flight control system according to claim 1,
wherein the sensor comprises at least one strain gauge, a piezoelectric sensor or a linear displacement sensor.

3. The mechanical flight control system according to claim 1,
wherein the force-measuring device or the actuator comprises the clocks.

4. The mechanical flight control system according to claim 1,
wherein, for at least one of the measurement channels, the electronic module comprises an analog-to-digital converter and the output interface comprises a digital bus.

5. The mechanical flight control system according to claim 1,
wherein at least one of the measurement channels comprises a memory wherein at least one calibration law is stored, and the duplex calculator(s) is/are configured to apply a calibration of the transfer value carried by the digital transfer signal for each measurement channel using the calibration law(s).

6. The mechanical flight control system according to claim 1,
wherein the actuator comprises at least one memory wherein at least one calibration law is stored, and the duplex calculator(s) is/are configured to apply a calibration of the transfer value carried by the digital transfer signal for each measurement channel using the calibration law(s).

7. The mechanical flight control system according to claim 1,
wherein the actuator comprises two electric motors and two duplex calculators, the force-measuring device comprising two first measurement channels connected to the control channels of the two duplex calculators and two second measurement channels connected to the monitoring channels of the two duplex calculators, the first measurement channels being dissimilar to the second measurement channels.

8. An aircraft provided with at least one movable aerodynamic control surface for moving the aircraft, and at least one mechanical flight control system according to claim 1 for controlling the aerodynamic control surface.

9. A method for measuring a value representative of a force in the mechanical flight control system of the aircraft using a force-measuring device,
wherein, the force-measuring device being provided with at least two measurement channels each comprising a sensor arranged on a connecting rod of the mechanical flight control system, an electronic module and an output interface, the method comprises the following steps applied for each measurement channel of the force-measuring device:
generating an analog measurement signal using the sensor;
digitizing the analog measurement signal to form a digital measurement signal using the electronic module;
converting the digital measurement signal into a digital transfer signal by means of the electronic module, the digital transfer signal carrying a transfer value representative of the force in the mechanical flight control system; and
emitting, by the electronic module, the digital transfer signal to the output interface of the measurement channel; and
calibrating the transfer value by application of a calibration law, the calibration law comprising a single calibration formula, a table of calibration formulas, or a calibration table;
on at least one measurement channel, the digitization being carried out by a delta-sigma modulation clocked by a clock, the conversion being carried out by a Manchester coding and a low-voltage differential signalling.
